(19) United States
(12) Patent Application Publication
(10) Pub. No.: US 2023/0295810 A1
(43) Pub. Date: Sep. 21, 2023

(54) CATHODIC PROTECTION POLYPROPYLENE GRAPHITE REFERENCE ELECTRODE

(71) Applicant: Abdeljawad Abusneineh, Houston, TX (US)

(72) Inventor: Abdeljawad Abusneineh, Houston, TX (US)

(21) Appl. No.: 18/097,351

(22) Filed: Jan. 16, 2023

Related U.S. Application Data
(60) Provisional application No. 63/268,343, filed on Feb. 22, 2022.

(51) Int. Cl. C23F 13/22; C23F 13/18; C23F 13/16; G01N 17/02; G01N 17/00

(52) U.S. Cl. CPC C23F 13/22; C23F 13/16; C23F 13/18; G01N 17/006; G01N 17/02

(57) ABSTRACT

Disclosed herein is a reference half-cell including a tube including an electron interface made of polypropylene graphite, an electrolyte solution, a metal electrode, and a seal. Alternatively, the reference half-cell may be employed without an electrolyte solution and a seal. The electron interface along the first end of the tube may be either an integrated part of the tube or a component separate from and affixed at its ends to the tube to maintain the electron interface in a stationary position relative to the tube. The use of electrically conductive polypropylene for the electron interface provides a half-cell that has good electrically conductivity and high moisture inhibitiveness and, as a result, has an improved service life.

### CLAIM TO PRIORITY

This application claims priority to, and the benefit of, U.S. Prov. Appl. 63/268,343, filed Feb. 22, 2022, the disclosure of which is incorporated by reference in its entirety.

### FIELD OF INVENTION

This disclosure relates to potentiometric and electrochemical reference electrodes and their use in assessment of materials degradation in metals subject to corrosion in field measurements.

### BACKGROUND

Corrosion of metal in above or buried pipelines, in concrete, or in other structures is a major problem with respect to the durability and safety and integrity of the structure.

The acquisition of reliable information on the amount and rate of corrosion of metal may be done by regular inspections if the metal is visible such as an above-ground pipeline. If the pipeline is below-ground or the metal is embedded in another material like concrete, electrochemical techniques may be employed to measure the corrosion.

In a typical electrochemical technique for measuring corrosion in metal, the electrochemical potential of the metal can be measured using a standard half-cell.

The reference electrodes most widely used in buried pipeline applications use copper/copper sulphate (saturated) as the electrolyte; Cu/CuSO4 (sat). These are available in a variety of constructions for both permanent and portable applications.

Illustratively, the Cu/CuSO4 (sat) comprises a pure copper electrode immersed in an electrolyte solution of super-saturated copper sulphate. The electrolyte is contained within a container. The container may be porous or non-porous. On one end, the container is fitted with a porous plug. The plug may be made from hardwood, porous sintered glass, porous ceramic or porous plastic. On the other end, the container is fitted with an insulating seal which holds the immersed end of the electrode in the solution. The end of the electrode extending outside of the insulating seal is provided with a wire for use in connecting the electrode to an instrument.

The porous plug, and in cases where a porous container is also used, the porous container also, enables ionic contact between the electrode extending into the container of electrolyte solution of super-saturated copper sulphate and the buried pipeline via the soil, sufficient to allow measurement of the voltage or potential between them. In operation, the electrode, maintained in the saturated copper sulphate electrolyte, is in a near equilibrium reversible redox reaction:

$$C u \text{2++} 2 e - ⇌ C u \left(m e t a l l i c\right)$$

The Nernst equation defines the dependence of the electrode potential on concentration (or activity) of the copper ions and temperature:

$$E = E C u / C u 2 \text{+0+} R T 2 F \text{} ln \text{} a C u 2 \text{+}$$

To measure the corrosion of a buried pipeline, for example, a set of reference electrode half cells, sometimes referred to as the anodic half-cell, may be placed on top of the soil at intervals along the buried pipeline with the porous plug facing the soil and connected to a negative terminal of a high-resistance voltmeter. A positive terminal of the high-resistance voltmeter may be connected to a typically plastic-sheathed steel probe which extends into the soil and touches the pipeline to be tested. To measure the corrosion of steel in concrete, an anodic half-cell typically placed on a sponge seated on moist concrete is connected to the negative terminal of the high-resistance voltmeter while a steel probe extends through the concrete to touch the metal in the concrete to be tested. In either case, a read-out from the high-resistance voltmeter may indicate the presence and extent of corrosion. For example, at 25° C. the copper/copper sulphate electrode has a potential of approximately +0.316 V with respect to the Standard Hydrogen Electrode (SHE). If the high-resistance voltmeter indicates a voltage of +0.500 V, the voltage increase indicates there to be corrosive activity on the metal.

A reference electrode must have specific electrical, physical and chemical properties. It must facilitate the measurement of accurate pipe/soil/reference electrode potentials on pipelines. It must also ideally have a stability that is sustainable for years.

Reference electrodes must operate without excessive electrode potential change in varying conditions and must be resistant to specific reactions within electrolytes in which they are installed. An example that causes changes in the electrode potential is a chloride containing environment which can cause contamination and hydrated cupric chloride to form on the copper/copper sulphate reference electrodes. All reference electrode potentials are affected by temperature.

As previously explained, in conventional reference half-cells, the electrolyte is contained within a container which is either fitted with a porous plug (this may be hardwood, porous sintered glass, porous ceramic or porous plastic) or is itself a porous container. The porosity of the plugs or porous containers allow saturated solution and moisture to leach out from the reference electrode, which reduces the stability, accuracy and service life of the reference electrode, especially in dry environments.

The use of a porous plug alone or with a porous container is especially problematic since it may also allow the electrolyte to get contaminated from the environment with which the porous plug or porous container is exposed, causing the reference electrode to fail. Dry and high resistivity soil will also cause inaccurate reading.

Using gel-based material to maintain moisture inside reference electrode will increase the service life of the half-cell by limiting the diffusion of electrolyte through the porous plug. Historically permanent Cu/CuSO4 (sat) reference electrodes have used ‘gelling agents’ of wood dust (saw dust) and ‘plaster of Paris’ (gypsum plaster, or calcined gypsum, CaSO4.0.5 H2O, which re-hydrates to CaSO4.2H2O when mixed with water when used.) The latter has also been used in a variety of Ag/AgCl/ KCI portable and permanent electrodes. But they do not prevent the electrolyte to leach, and so they will also not prevent contamination.

There is a need for a reference half-cell that minimizes these and other problems. This disclosure addresses that need.

### SUMMARY

In the present invention, I have devised a reference half-cell that that is electrically conductive and moisture inhibitive and accordingly has a much longer service life. In one embodiment of my invention, the reference half-cell comprises a tube for immersing an electrode in a saturated electrolyte solution contained by the tube and which provides an electron interface. In another embodiment, a tube is configured to provide an electron interface without employing a saturated electrolyte solution. At least the electron interface is made from an electrically conductive polypropylene that is electrically conductive and moisture inhibitive. The electron interface lies coaxially with the tube and is either an integrated part of the tube or affixed at its ends to the tube to maintain the electron interface in stationary position to said tube.

I have found that such use of electrically conductive polypropylene for the electron interface provides a half-cell that has good electrically conductivity and high moisture inhibitiveness and, as a result, has an improved service life.

My reference half-cell may be used in a metal corrosion detection system in which a monitoring and overall assessment of the electrochemical corrosion and coatings condition in a metal is provided. In such system, my reference half-cell measures a potential of a metal. The measured potential indicates an amount of corrosion of the metal and the level of metal protection provided by the coatings and cathodic protection system.

My invention includes a method for measuring a potential which corresponds to a polarization of a metal. The method includes employing my inventive reference half-cell in a cathodic protection system. The measured potential indicates an amount of corrosion of the metal and the amount of metal coatings loss. The method provides an effective method for easily measuring corrosion in metal.

My invention includes a method for manufacturing my inventive reference half-cell. The method forms a half-cell tube with an electron interface formed from a non-porous electrically conductive polypropylene material. The half-cell tube may be filled with an electrolyte solution into which is immersed a metal electrode. If the half-cell tube is filled with an electrolyte solution, a seal is provided along an open end of the half-cell tube about the metal electrode to contain the electrolyte solute within and the metal electrode to the half-cell tube. The electron interface of the half-cell tube may be formed to be an integral part of the half-cell tube or separate from and affixed to the half-cell tube.

Additional objects and advantages of the invention will be set forth in part in the description which follows, and, in part, will be obvious from the description, or may be learned by practice of the invention.

### DESCRIPTION OF DRAWINGS

FIG. 1A depicts an illustrative embodiment of my reference half-cell 10 according to my invention wherein an electron interface 25 along a first end 26a,b of the tube 25 is an integrated part of the tube. FIG. 1B depicts a top view of the reference half-cell 10 depicted in FIG. 1A, and FIG. 1C depicts a bottom view of the reference half-cell 10 depicted in FIG. 1A. FIGS. 1A, 1B, 1C collectively comprise FIG. 1.

FIG. 2A depicts an illustrative embodiment of my reference half-cell 110 according to my invention wherein an electron interface 125 along a first end 126a,b of the tube 120 is a component separate from and affixed at its ends to the tube 120 to maintain the electron interface 125 in a stationary position relative to the tube 120. FIG. 2B depicts a top view of the reference half-cell 110 depicted in FIG. 2A, and FIG. 2C depicts a bottom view of the reference half-cell 110 depicted in FIG. 2A. FIGS. 2A, 2B, 2C collectively comprise FIG. 2.

FIG. 3A depicts an alternative embodiment of my disclosure wherein the reference half-cell is provided without electrolyte. FIG. 3B depicts a top view of the reference half-cell 210 depicted in FIG. 3A, and FIG. 3C depicts a bottom view of the reference half-cell 210 depicted in FIG. 3A. FIGS. 3A, 3B, 3C collectively comprise FIG. 3.

FIG. 4 depicts an illustrative method 200 for fabricating a reference half-cell for use in corrosion monitoring of a metal,

FIG. 5 depicts an illustrative application of my inventive reference half-cell for corrosion monitoring of an underground pipeline.

FIG. 6 depicts an illustrative application of my inventive reference half-cell for corrosion monitoring of rebar in cement.

FIG. 7 depicts an illustrative method for using the inventive reference half-cell for corrosion monitoring of a metal.

FIG. 8 depicts a broadened illustrative method for making my inventive reference half-cell for corrosion monitoring of a metal.

FIG. 9 depicts an illustrative method for making my inventive reference half-cell depicted in FIG. 3 for corrosion monitoring of a metal.

### DETAILED DESCRIPTION

In the following detailed description, reference is made to the accompanying drawings that form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

By the term “corrosion protection” is meant monitoring of a metal for corrosion.

Broadly speaking, disclosed herein is a reference half-cell including a tube including an electron interface made of polypropylene graphite, an electrolyte solution, a metal electrode, and a seal. The reference half-cell may also be configured without an electrolyte solution and a seal. The electron interface along the first end of the tube may be either an integrated part of the tube or a component separate from and affixed at its ends to the tube to maintain the electron interface in a stationary position relative the tube. The use of electrically conductive polypropylene for the electron interface provides a half-cell that has good electrically conductivity and high moisture inhibitiveness and, as a result, has an improved service life.

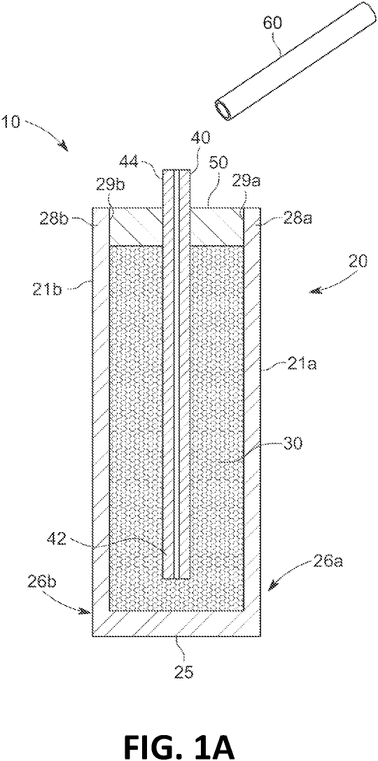

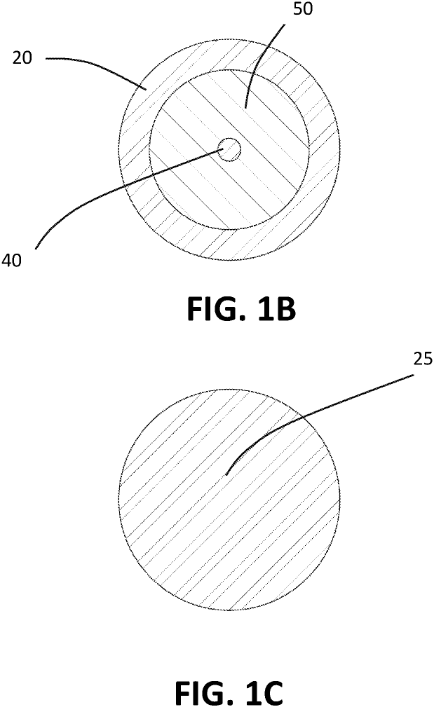

FIG. 1 depicts one illustrative embodiment of my reference half-cell 10 wherein the electron interface along a first end 26a,b of a tube 20 may be an integrated part of the tube. As shown in FIG. 1, a reference half-cell 10 includes a tube 20 including an electron interface 25, an electrolyte solution 30, a metal electrode 40, and a seal 50.

The tube 20 is provided with sidewalls 21a,b. The tube 20 includes the electron interface 25 along at least a first end 26a,b of the tube 20 and forms a portal neck 29a,b along a second end 28a,b of the tube 20.

The electrolyte solution 30 is contained by the tube 20 and is in contact with the electron interface 25.

In applications where the reference half-cell is to be used to measure corrosion of underground pipes, the electrode is maintained in a saturated copper sulphate electrolyte, which is in a near equilibrium reversible redox reaction:

$$C u \text{2++} 2 e - ⇌ C u \left(m e t a l l i c\right)$$

The Nernst equation defines the dependence of the electrode potential on concentration (or activity) of the copper ions and temperature:

$$E = E C u / C u 2 \text{+0+} R T 2 F \text{} ln \text{} a C u 2 \text{+}$$

In other applications of the reference half-cell of this disclosure, other saturated electrolytes may be used. For example, for detection of corrosion in soil and reinforced concrete applications, a copper/copper sulfate electrode (Cu/CuSO4) or silver/silver chloride electrode (Ag/AgCl) may be used for the half-cell reference. For detection of corrosion of metals in ships and vessels, a silver/silver chloride (Ag/AgCl) may be used for the half-cell reference. Table 1 shows some illustrative saturated electrolytes useable with the half-cell reference of my disclosure. Any of these or other saturated electrolytes for these or other applications are within the teachings of my disclosure.

| Half-Cell | Potential Ref. SHE (v) | Environment |
|---|---|---|
| Copper : Copper Sulfate | +0.3160 | Soil |
| Tenth Normal Calomel | +0.3337 | Laboratory |
| Normal Calomel | +0.2800 | Laboratory |
| Saturated Calomel | +0.2415 | Laboratory |
| Silver : Silver Chloride (0.1 M KCl) | +0.2880 | Seawater |
| Silver : Silver Chloride (Seawater) | +0.2222 | Seawater |
| Silver : Silver Chloride (3.8 M KCl) | +0.1990 | Seawater |
| Hydrogen | 0 | Laboratory |
| Zinc | -0.7600 | Seawater |

The metal electrode 40 includes a first end 42 and a second end 44. The metal electrode 40 is immersed into the electrolyte solution 30 at the first end 42 and extends outwardly away from the tube 20 at the second end 44. The second end 44 of the metal electrode 40 is configured to receive a wire lead 60.

The metal electrode 40 may be made from any conductive material. Illustratively, the metal electrode made of copper may be used. Alternatively, the metal electrode may be made of silver, zinc, and so on. Depending on the nature of the application, electrodes may also be made from graphite, noble metals (gold, silver or platinum). Titanium and brass may also be used. The metal for use as metal electrode 40 is a design choice known to those skilled in the art.

The seal 50 is illustratively formed from epoxy or polyvinyl chloride. Alternatively, the seal may be formed from any material suitable for the reference half-cell design. The material for use as seal 50 is a design choice known to those skilled in the art. The seal 50 is inserted into the portal neck 29a,b of the tube 20 along the second end 28a,b of the tube 20 around the metal electrode 40. As depicted in FIG. 1B, the seal 50 is securely retained by the portal forming neck 29a,b of the tube 20 and the electrode 40. The seal 50 co-acts with the tube 20 to hold the metal electrode 40 securely to the tube 20 and to keep the first end 42 of the metal electrode 40 immersed into the electrolyte solution 30 and to keep the electrolyte solution 30 contained within the tube 20.

The electron interface 25 along the first end 26 of the tube 20 is either an integrated part of the tube or a component separate from and affixed at its ends to the tube to maintain the electron interface in a stationary position relative to the tube.

In FIG. 1, my reference half-cell 10 depicted is wherein the electron interface 25 along the first end 26a,b of the tube 25 is an integrated part of the tube.

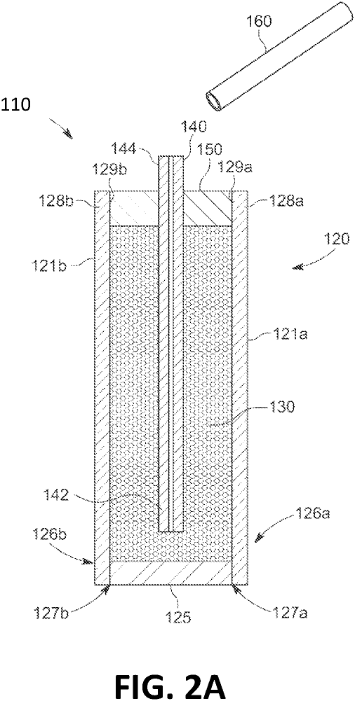

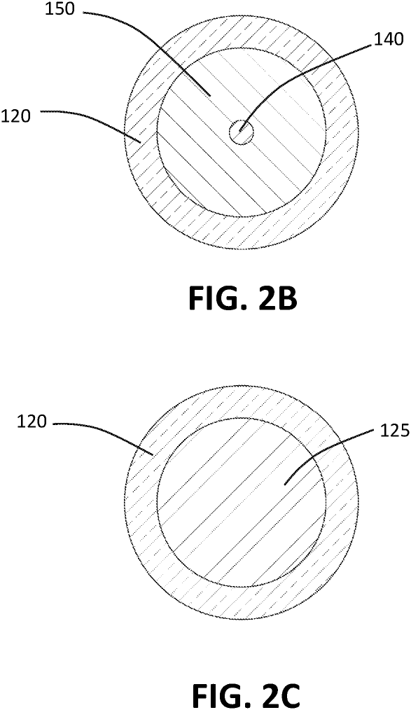

FIG. 2 depicts an alternative illustrative embodiment of my reference half-cell 110 wherein the electron interface 125 along the first end 126a,b of the tube 25 is a component separate from and affixed to the tube 120. Except for one functional feature, the functional features in FIG. 2 are like the functional features depicted in FIG. 1 and are indicated by the same reference number used in FIG. 1 increased by “100.” The disclosure of each of these elements is as explained in connection with the disclosure of these like elements in FIG. 1.

The functional feature that is different in FIG. 2 is the electron interface 125 along the first end 126a,b of the tube 125. Unlike in FIG. 1, where the electron interface 25 is an integral part of the body of the tube 25, in FIG. 2, electron interface 125 is depicted as a component that is separate from and affixed at its ends to the tube 120 to maintain the electron interface 125 in a stationary position relative to the tube 120.

The description of the function and composition of electron interface 125 in FIG. 2 is like that of electron interface 25 in FIG. 1 except that the electron interface 125 further includes a means for securing 127a,b the electron interface 125 to the tube 120 which is a component separate from the electron interface 125. The means for securing 127a,b is preferably thermal bonding. Alternatively, an adhesive may be used as can other medium for fixing material makeup of the electron interface 125 to the polyvinyl chloride or other material used for the tube 120. Where the electrode interface is an integrated part of the tube as depicted in FIG. 1, the electrode interface 25 provides a closed end to the first end 26a,b of the tube 20.

Turning now to the electron interface 25, 125 of my invention depicted in FIGS. 1, 2, respectively, the electron interface 25, 125 is made from a non-porous electrically conductive polypropylene. Advantageously, the electron interface inhibits moisture penetration while enhancing electron migration from a solution containing a metal to be tested for corrosion. In the embodiment depicted in FIG. 1, both the electron interface 25 and the side walls 21a,b of the tube are formed from an electrically conductive polypropylene. In the embodiment depicted in FIG. 2, the electron interface 125 may be formed from an electrically conductive polypropylene while the separate component of the tube 120 may be formed from polyvinylchloride (PVC) or other material.

It will be appreciated that where the electrode interface is a component separate from and affixed at its ends to the tube, the electrode interface provides a closed end to the second end of the tube.

Illustratively, the electrically conductive polypropylene material that forms the closed-ended part of tube 20 depicted in FIG. 1 and that provides the electron interface plug in the embodiment depicted in FIG. 2 is TECACOMP PP HTE black 1014973. Alternatively, the material may be XPE-0100 or any other electrically conductive polypropylene material that provides the appropriate electron interface between the saturated solution electrolyte and the solution between the reference half-cell and the metal to be measured for corrosion.

Broadly speaking, the electron interface 25, 125 of this disclosure is composed of carbon-polymer based composite materials. The carbon components provide the necessary electrical conductivity. Raw materials such as graphite fibers and powders are usually used as major conductive components. In some cases carbon black, carbon nanotubes, exfoliated graphite and others may be applied as minor or major fillers to provide improved conductivity to the composite material.

Illustratively, the polymer or binder matrix, respectively, may be composed of thermoplastic or thermoset polymers such as polypropylene, polyethylene, fluoroelastomer, polyphenylene sulfide, diverse rubbers (butyl rubber, ethylene-propylene rubber, ethylene-propylene diene monomer rubber, nitrile rubber), styrene-ethylene-butylene-styrene elastomer, nylon, epoxy or phenolic resin. The polymer and binder matrix is known in the art and a choice dependent upon the electrical conductivity and moisture inhibition properties desired for the electron interface design. See, e.g., Review-Bipolar Plates for the Vanadium Redox Flow Battery, Barbara Satolaz Journal of The Electrochemical Society, 2021 168 060503, which is incorporated by reference.

Illustratively, the ratio of the major conductive component, such as graphite, may be usually around 80 wt%. Sometimes further minor bridge material with high electrical conductivity or with properties of increasing flowability of the composite matrix may be added in small amounts usually up to 4 wt%. The remaining percentage may be filled with insulating polymer as binder matrix. An appropriate selection and composition between the single components of the composite material is important. Their selection is known in the art and a choice dependent upon the electrical conductivity and moisture inhibition properties desired for the electron interface design. See, e.g., Review-Bipolar Plates for the Vanadium Redox Flow Battery, Barbara Satolaz Journal of The Electrochemical Society, 2021 168 060503, which is incorporated by reference.

Illustratively, the electron interface of my disclosure may be fabricated by compression and injection molding. The fabrication process is known in the art and a design choice. See, e.g., Review-Bipolar Plates for the Vanadium Redox Flow Battery, Barbara Satolaz Journal of The Electrochemical Society, 2021 168 060503, which is incorporated by reference.

In an illustrative embodiment depicted in both FIGS. 1 and 2, a tube 20, 120, respectively having an ID and OD of 1.5 inches and 2.0 inches, respectively may be used along with an electrode of .25 inch diameter and a length sufficient to extend into the tube so as to be close to the inside surface of the electron interface and leaving about a .25 inch length extending out of the seal so as to provide a point of contract for the lead. The wire lead may be a copper wire. Alternatively, any wire of metal having properties suitable for the conduction of current may be used. Illustratively, a seal having a diameter of 1.5 inches and thickness of .5 inches may be used. Illustratively, Copper : Copper Sulfate may be used as the electrolyte 30 for a reference half-cell for use in corrosion detection buried metal pipes or metal in cement. As previously explained, other electrolytes may be used for other corrosion detection.

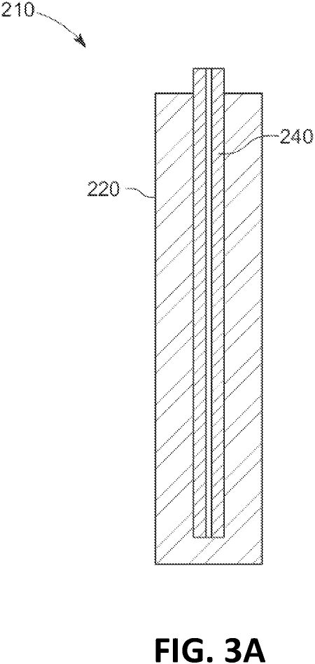

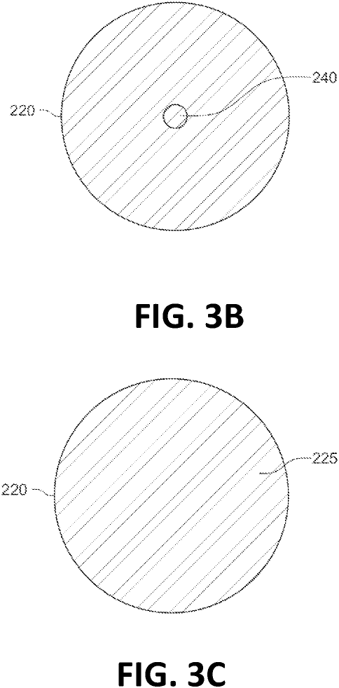

FIG. 3 depicts an alternative embodiment of my reference half-cell 210 wherein the electron interface 225 along a first end 226a,b of a tube 220 may be an integrated part of the tube. As shown in FIG. 3, a reference half-cell 210 includes a tube 220 including an electron interface 225, a metal electrode 240 but no electrolyte solution and no seal. Except for the absence of functional features of the electrolyte 30 depicted in FIG. 1 and the seal 50 depicted in FIG. 1, the functional features in FIG. 3 are like the functional features depicted in FIG. 1 and are indicated by the same reference number used in FIG. 1 increased by “200.” The disclosure of each of these elements is as explained in connection with the disclosure of these like elements in FIG. 1.

The functional feature that is different in FIG. 3 is the absence of the electrolyte 30 depicted in FIG. 1 and the seal 50 depicted in FIG. 1. Instead of an electrolyte 30 depicted in FIG. 1, the tube 220 adjoins and so is in direct electrical contact with metal electrode 240. In this embodiment, the absence of the electrolyte does away with the Nernst equation in the operation of the reference half-cell. In addition, without electrolyte, the half-cell will provide a potential reading, but the accuracy of the reading will not last because of the oxidization that will occur on the copper rod. Using electrolyte to employ the Nernst equation in a Redox system will protect the metal(copper) and maintain long life and accuracy. Still, my disclosed reference half-cell of FIG. 3 provides good reading for short term applications.

Also in this embodiment, the metal electrode is held in position by the tube 220 itself; thereby doing away with the need for a seal 50 as required in the FIG. 1 embodiment.

Common use of metal for use for metal electrode for potential reading without electrolyte may be zinc metal. See, for example, https://www matcor.com/products/zine-reference-electrodes/ which is incorporated herein by reference.

The embodiment depicted in FIG. 3 provides good potential readings across a high-resistance voltmeter in use in a closed look circuit as herein described albeit having a shorter life in some applications due to the oxidation on the metal electrode due to the absence of an electrolyte solution in this embodiment.

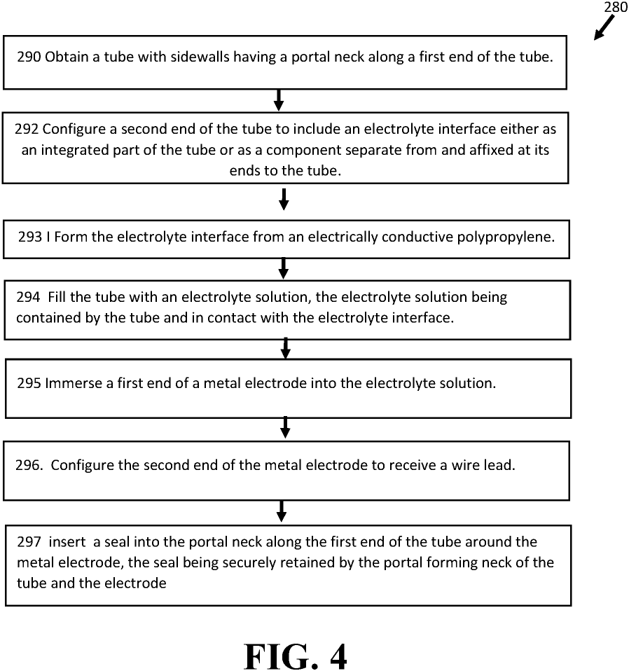

FIG. 4 depicts an illustrative method 280 for fabricating a reference half-cell for use in cathodic protection. I obtain 290 a tube with sidewalls having a portal neck along a first end of the tube. I configure 292 a second end of the tube to include an electron interface either as an integrated part of the tube or as a component separate from and affixed at its ends to the tube. I form 293 the electron interface from an electrically conductive polypropylene. I fill 294 the tube with an electrolyte solution, the electrolyte solution being contained by the tube and in contact with the electron interface. I immerse 295 a first end of a metal electrode into the electrolyte solution. I configure 296 the second end of the metal electrode to receive a wire lead. I insert 297 a seal into the portal neck along the first end of the tube around the metal electrode, the seal being securely retained by the portal forming neck of the tube and the electrode, the seal co-acting with the tube to hold the metal electrode securely to the tube and to keep the first end of the metal electrode immersed into the electrolyte solution and to keep the electrolyte solution contained within the tube.

In one illustrative embodiment, I configure the electron interface of the second end of the tube configured to include an electron interface to be an integrated part of the tube as depicted in FIG. 1.

In another illustrative embodiment, I configure the electron interface of the second end of the tube configured to include an electron interface to be a component separate from and affixed at its ends to the tube; and I form the sidewalls from polyvinyl chloride as depicted in FIG. 2.

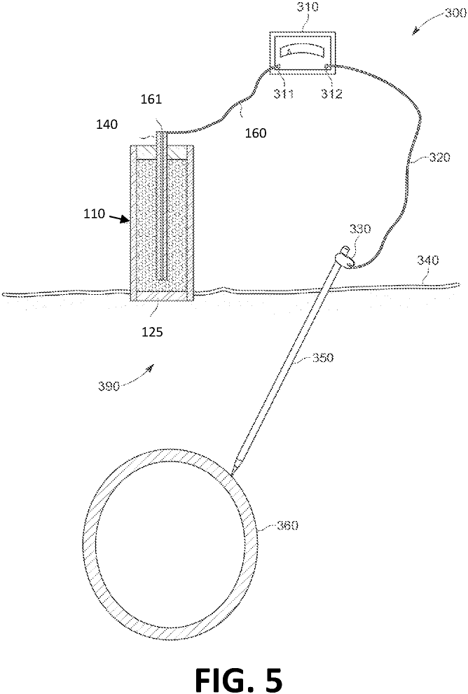

FIG. 5 depicts an illustrative application 300 of my inventive reference half-cell depicted in FIG. 2 for corrosion monitoring of an underground pipeline. As shown, the previously explained electrolyte half-cell 110 is positioned in an up-right direction with respect to soil 340 such that the previously explained electron interface 125 of the electrolyte half-cell 110 lies against the soil. The previously explained wire lead 160 is attached at a first end 161 to the previously explained electrode 140 of the reference half-cell. At a second end 311, the wire lead 160 is connected to a negative terminal of a high resistance voltmeter 310. A wire lead 320 is connected at a first end 312 to a positive terminal of the high resistance voltmeter 310 and at a second end 330 to a plastic sheathed steel probe 350 which is connected to a buried steel pipe 360. Moisture 390 in the soil 340 completes the corrosion prevention circuit.

In operation, electrons from the buried pipe 360 migrate through the moisture 390 in the soil 340 to the reference half-cell 110 and through the electron interface 125 of the reference half-cell. As previously explained, advantageously, the electrically conductive, moisture inhibitive features of my novel electron interface 125 allows the electrons to be conducted through the electron interface 125 while the electron interface 125 keeps the electrolyte solution contained within the reference half-cell from leaching out. Without corrosion of the metal, there is a flow of electrons out of the reference half-cell 110 along wire lead 160, through the high-resistance voltmeter 310, along wire lead 320, along plastic-sheathed steel probe 350 and back to the buried steel pipe 360 to complete the circuit. Without corrosion, the flow of electrons out of the reference half-cell along wire lead 160 provides a reference voltage, typically about .32 V in the instant application. As a metal may corrode, that corrosive action generates electrons as part of the process as previously explained which increases the flow of electrons along lead 160 and hence generates a higher voltage level across the high-resistance voltmeter 310 than the reference voltage. By monitoring the voltage read-out from the high-resistance voltmeter 310 in the described system for detecting corrosion, the corrosion of the buried metal pipe may be monitored. If the level of corrosion becomes significant, corrective action may be taken to either replace the pipe or the section of the pipe that is corroded.

While the foregoing example is illustrated using my inventive reference half-cell 110 of FIG. 2, my inventive reference half-cell 10 of FIG. 1 may also be used instead of the half-cell 110 of FIG. 2 in this example.

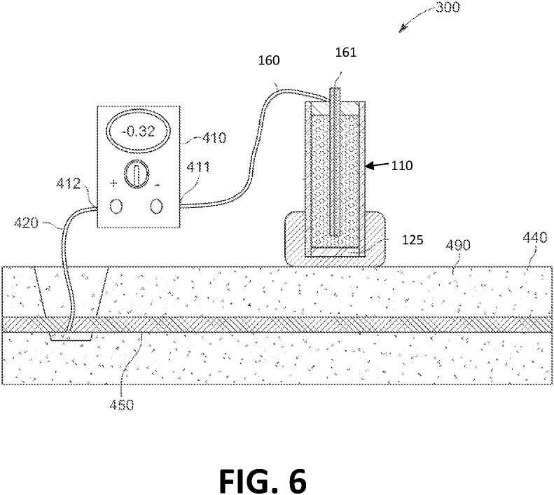

FIG. 6 depicts an illustrative application of my inventive reference half-cell depicted in FIG. 2 for corrosion monitoring of rebar in cement. As shown, the previously explained electrolyte half-cell 110 is positioned in an up-right direction with respect to cement 440 such that the previously explained electron interface 225 of the electrolyte half-cell 120 lies against a wall of the cement 440. The previously explained wire lead 260 is attached at a first end 2261 to the previously explained electrode 140 of the reference half-cell. At a second end 411, the wire lead 160 is connected to a negative terminal of a high resistance voltmeter 410. A wire lead 420 is connected at a first end 412 to a positive terminal of the high resistance voltmeter 410 and at a second end 430 to a metal lead 420 which is connected to a metal rebar 450 embedded in the cement 440. Moisture 490 in the cement 440 completes the corrosion prevention circuit.

In operation, electrons from the rebar 450 migrate through the moisture 490 in the cement 440 to the reference half-cell 110 and through the electron interface 125 of the reference half-cell. As previously explained, advantageously, the electrically conductive, moisture inhibitive features of my novel electron interface 125 allows the electrons to be conducted through the electron interface 125 while the electron interface 125 keeps the electrolyte solution contained within the reference half-cell from leaching out. Without corrosion of the metal, there is a flow of electrons out of the reference half-cell 110 along wire lead 160, through the high-resistance voltmeter 410, along wire lead 420, along wire lead 420 and back to the rebar 450 to complete the circuit. Without corrosion, the flow of electrons out of the reference half-cell along wire lead 160 provides a reference voltage. As a metal may corrode, that corrosive action generates electrons as part of the process as previously explained which increases the flow of electrons along lead 160 and hence generates a higher voltage level across the high-resistance voltmeter 410 than the reference voltage. By monitoring the voltage read-out from the high-resistance voltmeter 410 in the described system for detecting corrosion, the corrosion of the rebar may be monitored. If the level of corrosion becomes significant, corrective action may be taken to either replace the rebar or the section of the rebar that is corroded or redo the cement with embedded rebar structure.

While the foregoing example is illustrated using my inventive reference half-cell 110 of FIG. 2, my inventive reference half-cell depicted in FIG. 1 may also be used instead of my reference half-cell depicted in FIG. 2 in this example.

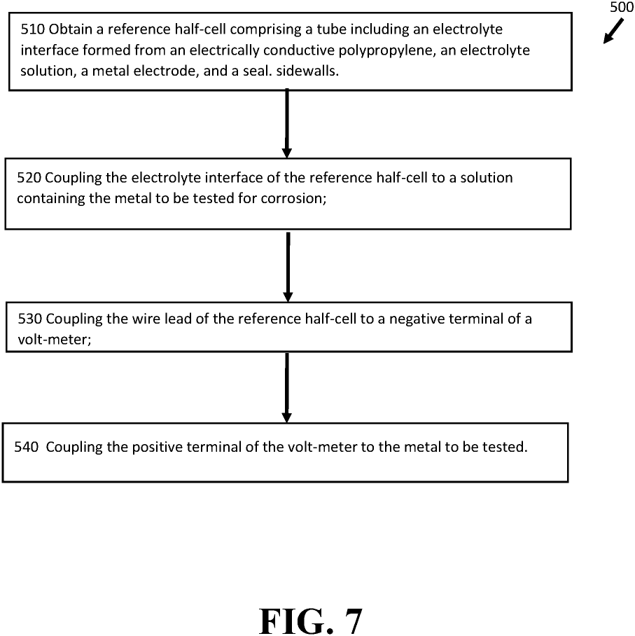

FIG. 7 depicts an illustrative method for using the inventive reference half-cell for corrosion monitoring of a metal.

In a method for cathodic protection 500, I obtain 510 a reference half-cell comprising a tube including an electron interface, an electrolyte solution, a metal electrode, and a seal. The tube includes sidewalls. The tube includes an electron interface along a first end and forms a portal neck along a second end. The electrolyte solution is contained by the tube and in contact with the electron interface. The metal electrode includes a first and a second end, the electrode being immersed into the electrolyte solution at the first end and extends outwardly away from the tube at a second end. The second end of the metal electrode is secured to a wire lead. The seal is inserted into the portal neck along the second end of the tube around the metal electrode, the seal being securely retained by the portal forming neck of the tube and the electrode, the seal co-acting with the tube to hold the metal electrode securely to the tube and to keep the first end of the metal electrode immersed into the electrolyte solution and to keep the electrolyte solution contained within the tube. The electron interface along the first end of the tube is either an integrated part of the tube or a component separate from and affixed at its ends to the tube to maintain the electron interface in stationary position to the tube. The electron interface is formed from an electrically conductive polypropylene. The electron interface inhibits moisture penetration while enhancing electron migration from a solution containing a metal to be tested for corrosion. I couple 520 the electron interface of the reference half-cell to a solution containing the metal to be tested for corrosion. I couple 530 the wire lead of the reference half-cell to a negative terminal of a volt-meter. I couple 540 the positive terminal of the volt-meter to the metal to be tested.

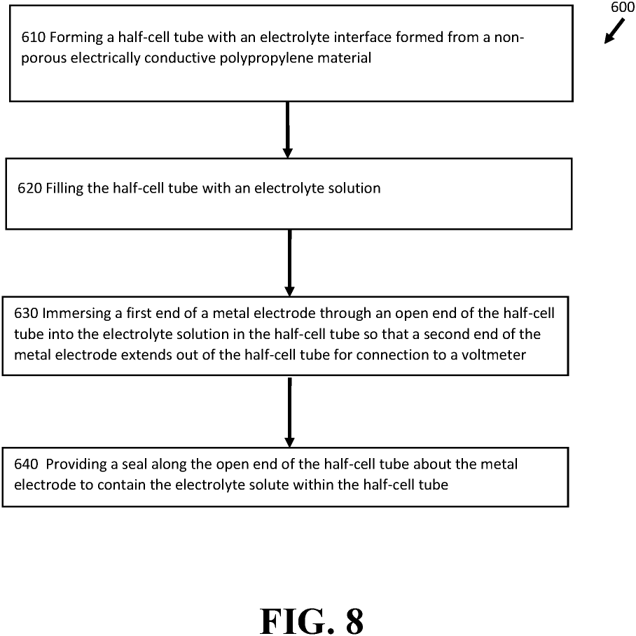

FIG. 8 depicts a broad illustrative method for making my inventive reference half-cell for corrosion monitoring of a metal.

The method begins by forming 610 a half-cell tube with an electron interface formed from a non-porous electrically conductive polypropylene material. The half-cell tube is filled 620 with an electrolyte solution. A first end of a metal electrode is immersed 630 through an open end of the half-cell tube into the electrolyte solution in the half-cell tube so that a second end of the metal electrode extends out of the half-cell tube for connection to a voltmeter. A seal is provided 640 along the open end of the half-cell tube about the metal electrode to contain the electrolyte solute within the half-cell tube.

In an illustrative method, the electron interface of the half-cell tube with an electron interface formed from a non-porous electrically conductive polypropylene material is formed to be an integral part of the half-cell tube. In an alternative method, the electron interface of the half-cell tube with an electron interface formed from a non-porous electrically conductive polypropylene material is formed to be separate from the half-cell tube and the method further comprises the step of securing the electron interface to the separate half-cell tube. In one method the step of securing the electron interface to the separate half-cell is by thermal bonding. In an alternative method, the step of securing the electron interface to the separate half-cell is by an adhesive.

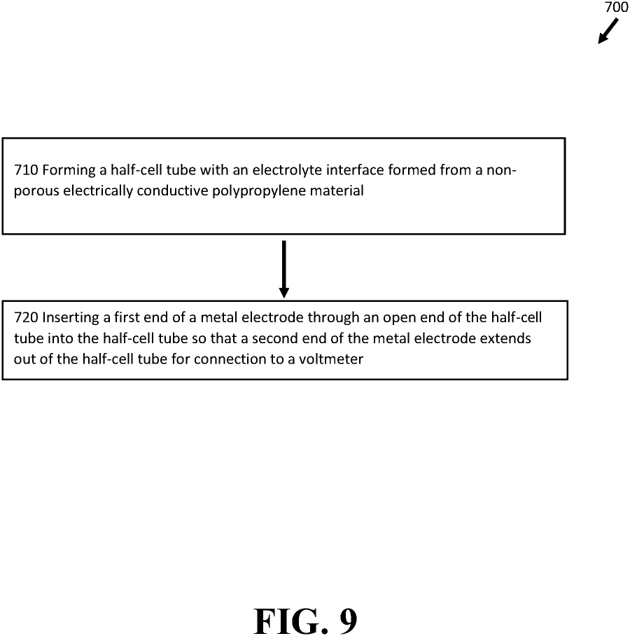

FIG. 9 depicts an illustrative method for making my inventive reference half-cell depicted in FIG. 3 for corrosion monitoring of a metal.

The method begins by forming 710 a half-cell tube with an electron interface formed from a non-porous electrically conductive polypropylene material. A first end of a metal electrode is inserted 730 through an open end of the half-cell tube into the half-cell tube so that a second end of the metal electrode extends out of the half-cell tube for connection to a voltmeter.

While this disclosure has been described in connection with specific embodiments, it is evident that numerous alternatives, modifications, and variations will be apparent to those skilled in the art within the spirit and scope of the above disclosure.

What is claimed is:

1. A reference half-cell comprising:
a tube with sidewalls, the tube including an electron interface along a first end and forming a portal neck along a second end;
an electrolyte solution, the electrolyte solution being contained by the tube and in contact with the electron interface;
a metal electrode including a first and a second end, the metal electrode being immersed into the electrolyte solution at the first end and extending outwardly away from the tube at the second end, the second end of the metal electrode configured to receive a wire lead;
a seal, the seal being inserted into the portal neck along the second end of the tube around the metal electrode, the seal being securely retained by the portal forming neck of the tube and the electrode, the seal co-acting with the tube to hold the metal electrode securely to the tube and to keep the first end of the metal electrode immersed in the electrolyte solution and to keep the electrolyte solution contained within the tube;
wherein the electron interface along the first end of the tube is either an integrated part of the tube or a component separate from and affixed at its ends to the tube to maintain the electron interface in stationary position relative to the tube;
wherein the electron interface is formed from an electrically conductive polypropylene;
wherein the electron interface inhibits moisture penetration while enhancing electron migration from a solution containing a metal to be tested for corrosion.

2. The reference half-cell of claim 1:
wherein the electrode interface is an integrated part of the tube; and
wherein the electrode interface provides a closed end to the first end of the tube.

3. The reference half-cell of claim 2:
wherein the sidewalls of the tube are formed from an electrically conductive polypropylene.

4. The reference half-cell of claim 1:
wherein the electrode interface is a component separate from and affixed at its ends to the tube; and
wherein the electrode interface provides a closed end to the first end of the tube.

5. The reference half-cell of claim 4:
wherein the electron interface is affixed at its ends to the tube with an adhesive.

6. The reference half-cell of claim 4:
wherein the electron interface is affixed at its ends to the tube by thermal welding.

5. The reference half-cell of claim 4:
wherein the sidewalls of the tube are formed from polyvinyl chloride.

6. The reference half-cell of claim 1 wherein the metal electrode is made from copper.

7. The reference half-cell of claim 1 wherein the metal rod is made from a metal selected from the group of metals consisting of silver, zinc, graphite, gold, silver, platinum, titanium and brass.

8. The reference half-cell of claim 1 wherein the electrolyte solution is a copper sulfate pentahydrate (CuSO4) solution.

9. The reference half-cell of claim 1 wherein the insulating seal is made from epoxy or polyvinyl chloride.

10. A method for fabricating a reference half-cell for use in cathodic protection, comprising:
obtaining a tube with sidewalls having a portal neck along a first end of the tube,
configuring a second end of the tube to include an electron interface either as an integrated part of the tube or as a component separate from and affixed at its ends to the tube;
forming the electron interface from an electrically conductive polypropylene;
filling the tube with an electrolyte solution, the electrolyte solution being contained by the tube and in contact with the electron interface;
immersing a first end of a metal electrode into the electrolyte solution configuring the second end of the metal electrode to receive a wire lead;
inserting a seal into the portal neck along the first end of the tube around the metal electrode, the seal being securely retained by the portal forming neck of the tube and the metal electrode, the seal co-acting with the tube to hold the metal electrode securely to the tube and to keep the first end of the metal electrode immersed into the electrolyte solution and to keep the electrolyte solution contained within the tube.

11. The method of claim 10 further comprising:
configuring the electron interface of the second end of the tube to be an integrated part of the tube.

12. The method of claim 10 further comprising:
configuring the electron interface of the second end of the tube to be a component separate from and affixed at its ends to the tube; and
forming the sidewalls from polyvinyl chloride.

13. The method of claim 12, wherein the affixing of the ends of the electron interface to the second end of the tube is by thermal bonding.

14. The method of claim 12, wherein the affixing of the ends of the electron interface to the second end of the tube is by use of an adhesive.

15. A method for cathodic protection comprising:
obtaining a reference half-cell, the reference half-cell comprising:
a tube with sidewalls, the tube including an electron interface along a first end and forming a portal neck along a second end;
an electrolyte solution, the electrolyte solution being contained by the tube and in contact with the electron interface;
a metal electrode including a first and a second end, the electrode being immersed into the electrolyte solution at the first end and extending outwardly away from the tube at a second end, the second end of the metal electrode being secured to a wire lead;
a seal, the seal being inserted into the portal neck along the second end of the tube around the metal electrode, the seal being securely retained by the portal forming neck of the tube and the electrode, the seal co-acting with the tube to hold the metal electrode securely to the tube and to keep the first end of the metal electrode immersed into the electrolyte solution and to keep the electrolyte solution contained within the tube;
wherein the electron interface along the first end of the tube is either an integrated part of the tube or a component separate from and affixed at its ends to the tube to maintain the electron interface in stationary position to the tube;
wherein the electron interface is formed from an electrically conductive polypropylene;
wherein the electron interface inhibits moisture penetration while enhancing electron migration from a solution containing a metal to be tested for corrosion.
coupling the electron interface of the reference half-cell to a solution containing the metal to be tested for corrosion;
coupling the wire lead of the reference half-cell to a negative terminal of a volt-meter;
coupling the positive terminal of the volt-meter to the metal to be tested.

16. A reference half-cell comprising:
a tube with sidewalls, the tube including an electron interface along a first end and forming a portal neck along a second end;
a metal electrode including a first and a second end, the metal electrode being inserted into the tube at the first end and extending outwardly away from the tube at the second end, the second end of the metal electrode configured to receive a wire lead;
wherein the electron interface along the first end of the tube is either an integrated part of the tube or a component separate from and affixed at its ends to the tube to maintain the electron interface in stationary position relative to the tube;
wherein the electron interface is formed from an electrically conductive polypropylene;
wherein the electron interface inhibits moisture penetration while enhancing electron migration from a solution containing a metal to be tested for corrosion.

17. The reference half-cell of claim 16:
wherein the electrode interface is an integrated part of the tube; and
wherein the electrode interface provides a closed end to the first end of the tube.

18. The reference half-cell of claim 17:
wherein the sidewalls of the tube are formed from an electrically conductive polypropylene.

19. The reference half-cell of claim 16:
wherein the electrode interface is a component separate from and affixed at its ends to the tube; and
wherein the electrode interface provides a closed end to the first end of the tube.
